(19) United States
(12) Patent Application Publication
(10) Pub. No.: US 2007/0234376 A1
(43) Pub. Date: Oct. 4, 2007

(54) Recording and reproducing device

(75) Inventor: Takeshi Makino, Echizen-city (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: ORION ELECTRIC CO., LTD., Echizen-city (JP)

(21) Appl. No.: 11/715,331

(22) Filed: Mar. 8, 2007

(30) Foreign Application Priority Data
Mar. 28, 2006 (JP) 2006-088825

(51) Int. Cl. G11B 17/028

(52) U.S. Cl. 720/712

(57) ABSTRACT

Noise produced when a turntable comes into contact with a damper is reduced without increasing the number of parts. A metallic support plate is suspended on a top surface of a frame and the support plate is provided with a damper facing a turntable. The support plate is provided with long holes so as to suppress vibration transmitting from the damper to the support plate when the turntable and the damper contact each other by means of the long holes. This restrains a sound of contact between the turntable and damper from being amplified through the vibration of the support plate.

The present application is based on and claims priority of Japanese patent application No. 2006-088825 filed on Mar. 28, 2006, the entire contents of which are hereby incorporated by reference.

### BACKGROUND OF THE INVENTION

1. Field of the Invention

The present invention relates to a recording and reproducing device which rotates a disk-shaped storage medium (hereinafter, simply referred to as a “disk”) by holding the disk by and between a turntable and a clamper, and more particularly, to a recording and reproducing device which can suppress a sound of contact between a damper and a turntable to a lowest possible level.

2. Description of the Related Art

A recording and reproducing device generally has the functions of rotating a storage medium such as a CD (Compact Disk) and DVD (Digital Versatile Disk) inside the device, irradiating laser light emitted from a pickup unit onto a recording surface of the rotating storage medium, receiving the laser light reflected by the recording surface of the storage medium using the pickup unit, thereby reading and reproducing information recorded in the storage medium beforehand or writing and recording information into the storage medium. When the recording and reproducing device performs recording or reproducing into/from the disk, the disk is held by and between a turntable provided on the recording surface side of the disk carried into the device by a conveying mechanism such as a tray and a roller, and a damper provided on the label surface side of the disk and the disk is rotated by a driving force of a motor which is connected with the turntable together with the damper and the turntable. Recording or reproduction into/from the disk is performed by irradiating laser light from the pickup unit onto the recording surface of the rotating disk and receiving reflected light by the pickup unit.

Main components such as the turntable and the pickup unit connected with the motor are mounted on a chassis, united as a traverse unit and attached to a frame. In this case, one end of the traverse unit is connected inside the frame through a buffering member and the other end of the traverse unit is connected with a slidable cam plate. The cam plate slides in conjunction with a conveying mechanism such as a tray and a roller carrying the disk and when the disk carried by the conveying mechanism reaches a predetermined position inside the device, the cam plate interlocked with the conveying mechanism slides and the other end of the traverse unit connected with the cam plate pivots on the one end of the traverse unit connected with the frame so as to ascend. This causes the turntable to engage with an opening formed substantially in the center of the disk located at a predetermined position and further ascend and causes the damper which is provided opposite to the turntable to push and hold the disk from the label surface side of the disk.

When the disk is held by and between the turntable and the clamper, for example, a magnet is attached to the interior of the damper and a magnetic substance is attached onto the surface of the turntable placed opposite to the damper so as to generate attraction between the magnet and the damper to thereby hold the disk. At this time, when a tray which can linearly move back and forth between the outside and inside of the device is used as the conveying mechanism of the disk, even when the disk is not mounted on the tray, the traverse unit ascends if the tray is carried into the device and the turntable and the damper attract each other without the disk.

In this way, when the turntable and the clamper attract each other without the disk and directly contact each other, a contact sound is generated. Especially, the number of revolutions of the turntable when reading and reproducing information recorded in the disk is different from the number of revolutions of the turntable. When specific numerical values are described, while the number of revolutions of the turntable during reproduction from the disk is approximately 3,000 rpm, the number of revolutions of the turntable during recording into the disk is approximately 9,000 rpm, and therefore in the case where a support plate for suspending the damper is formed of a metallic material to improve rigidity for a high-speed rotation of the turntable during recording into the disk, when the turntable comes into direct contact with the clamper, the contact sound is transmitted to the metallic support plate and amplified.

As a measure for such an abnormal sound at the time of contact between the turntable and the clamper, for example, Japanese Patent Laid-Open Publication No. 2003-223776 (patent document 1) describes a structure with a rubber ring interposed between the damper and disk and between the disk damper and the support plate as means for suppressing noise or vibration generated when the damper (the patent document 1 describes it as a “disk clamper”) collides with the disk or support plate (the patent document 1 describes it as a “clamper plate”).

As described above, when the support plate for suspending the damper is formed of a metallic material to improve rigidity, if the turntable and the damper directly contact each other, the contact sound is transmitted to the metallic support plate and amplified. As the measure for suppressing this contact sound, the structure described in the patent document 1 in which a rubber ring is interposed between the damper and support plate to reduce noise at the time of contact between the turntable and the damper not only takes time and trouble for attaching the rubber ring but also requires the rubber ring to be formed separately, which results in a problem of increasing manufacturing processes and causing a cost increase.

### SUMMARY OF THE INVENTION

The present invention has been implemented in view of the above described problems and it is an object of the present invention to provide a recording and reproducing device capable of reducing noise at the time of contact between the turntable and the damper without increasing the number of parts.

The recording and reproducing device according to a first aspect of the present invention is a recording and reproducing device including a conveying mechanism which conveys a disk-shaped storage medium, a frame to which the conveying mechanism is attached, a pickup unit which scans the storage medium carried into the frame, a turntable for rotating the storage medium, a damper provided opposite to the turntable; and a support plate suspended between side walls of the frame opposite to the clamper, the support plate being formed of a flat sheet metal, wherein long holes for suppressing vibration transmitting from the damper to the support plate when the damper comes into contact with the turntable are formed in the vicinity of the clamper.

The construction according to the first aspect of the present invention causes the traverse unit to ascend when the conveying mechanism enters the frame, restrains, when the turntable and the damper collide with each other, vibration transmitted from the damper to the support plate by means of the long holes formed in the support plate and restrains a sound of contact between the turntable and the damper from amplifying through the vibration of the support plate.

The recording and reproducing device according to a second aspect of the present invention is the recording and reproducing device according to the first aspect of the present invention, wherein when the damper is attached at a position deviated forward or backward with respect to the center of the support plate, the long holes are at least formed on a side having a wider area ahead or behind the clamper.

As the size of the support plate increases, the vibration transmitted from the damper to the support plate increases and noise caused by the vibration of the support plate also increases, and the construction according to the second aspect of the present invention forms long holes for restraining vibration transmitted from the damper to the side having a wider area of the support plate, and can thereby more effectively restrain noise produced by collision between the turntable and the clamper.

The recording and reproducing device according to a third aspect of the present invention is the recording and reproducing device according to the first aspect of the present invention, wherein the clamper is attached substantially in the center of the support plate and when the size of the support plate in a depth direction is shorter than the width of the support plate, the long holes are at least formed on both sides of the clamper.

The construction according to the third aspect of the present invention can effectively restrain the vibration transmitted to both sides of the support plate whose size in the depth direction is formed to be shorter than the width thereof by means of the long holes.

### BRIEF DESCRIPTION OF THE DRAWINGS

FIG. 1 is a perspective view of a disk device with long holes formed behind a damper according to an embodiment of the present invention;

FIG. 2 is a cross-sectional view along an A-A line of FIG. 1 according to the embodiment of the present invention;

FIG. 3 is a perspective view of the disk device with a long hole formed ahead of the clamper according to the embodiment of the present invention; and

FIG. 4 is a perspective view of the disk device with long holes formed on both sides of the clamper according to the embodiment of the present invention.

### DETAILED DESCRIPTION OF THE PREFERRED EMBODIMENTS

Hereinafter, as a specific embodiment of a recording and reproducing device (hereinafter, referred to as a “disk device”) of the present invention, a tray type disk device will be explained with reference to the attached drawings. The following embodiment is a mode in which the present invention is embodied and by no means is intended to limit the present invention to the scope thereof.

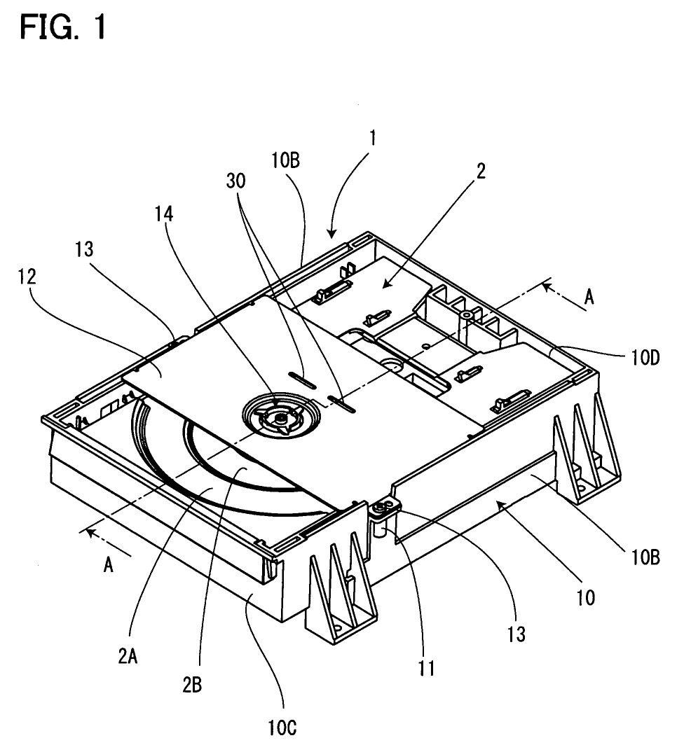

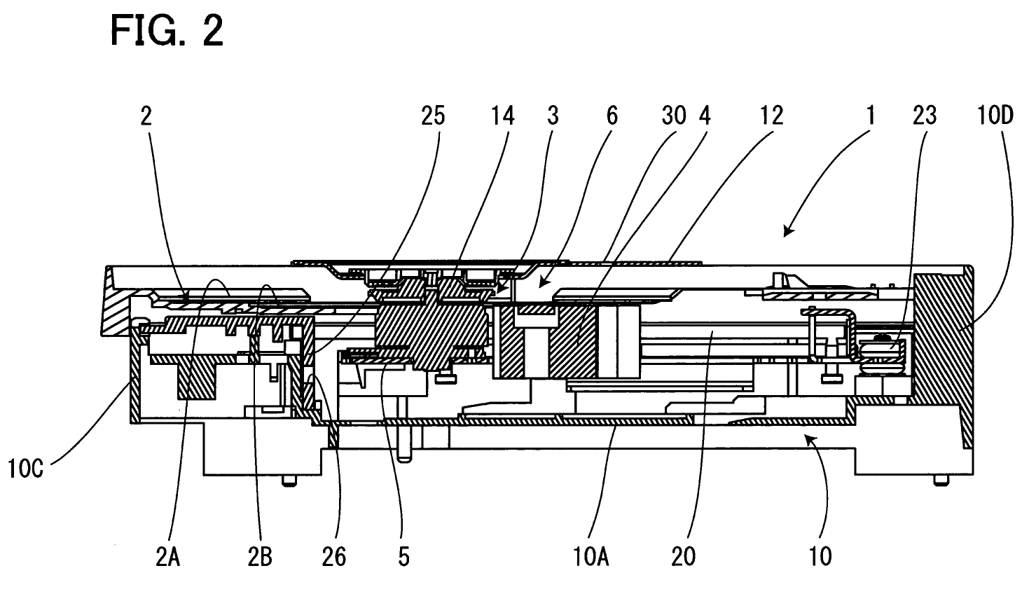

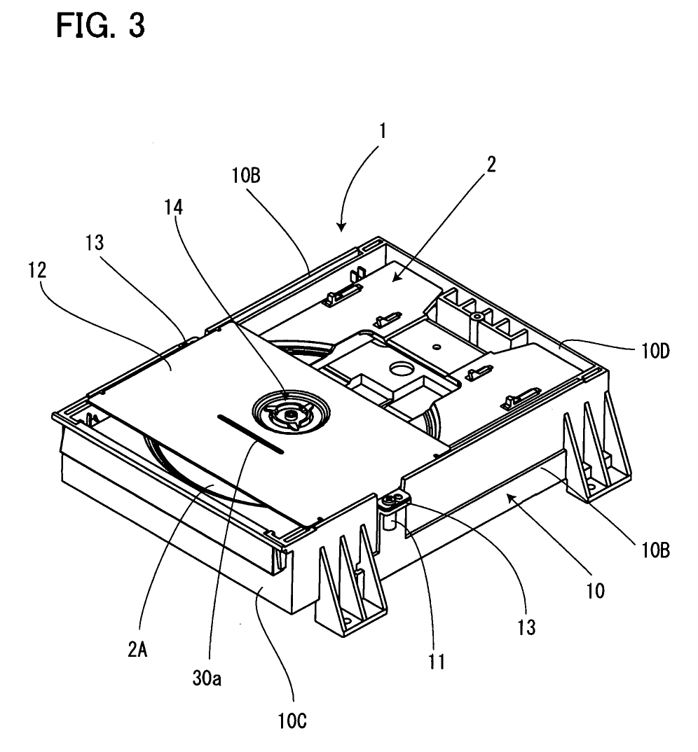

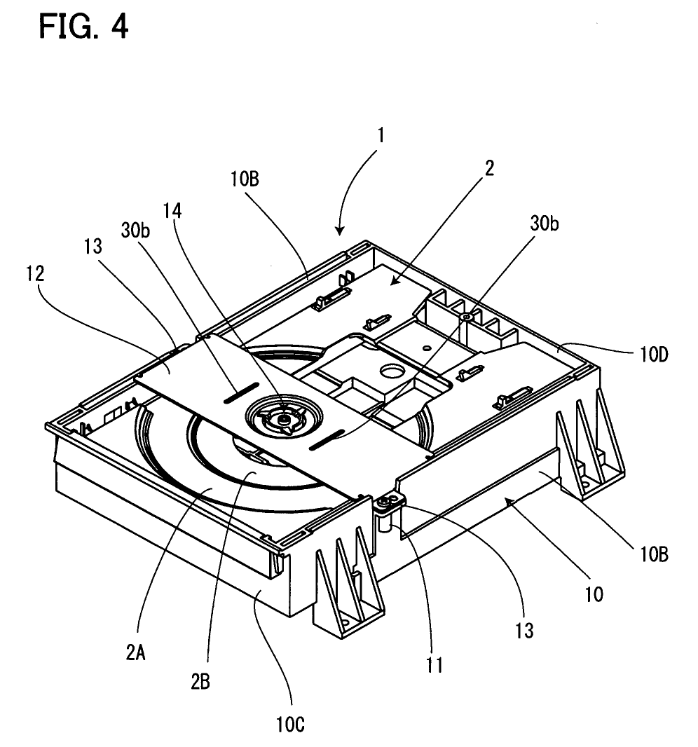

FIG. 1 to FIG. 4 show an embodiment of the present invention; FIG. 1 is a perspective view of a disk device with long holes formed behind a clamper, FIG. 2 is a cross-sectional view along an A-A line of FIG. 1, FIG. 3 is a perspective view of the disk device with a long hole formed ahead of the damper and FIG. 4 is a perspective view of the disk device with long holes formed on both sides of the clamper.

As shown in the same figure, the disk device 1 of this embodiment is constructed of a tray 2 as a conveying mechanism which carries in/out a disk (not shown), a traverse unit 6 made up of a turntable 3 which drives the disk to rotate and pickup unit 4 provided so as to be movable back and forth in a radial direction of the disk or the like, mounted on a metal chassis 5 as main components and a synthetic resin frame 10 in which these main components are assembled.

The frame 10 is formed of synthetic resin and constructed like a box with a bottom made up of a horizontal wall 10A, side walls 10B integrally molded on both left and right sides of the horizontal wall 10A, and a front wall 10C and a rear wall 10D integrally molded on the front and back of the horizontal wall 10A. A pair of left and right boss sections 11 are integrally molded on front outside surfaces of the side walls 10B and a support plate 12 made of a metallic sheet is fixed to these boss sections 11 using screws 13. A clamper 14 facing the turntable 3 is fixed to the support plate 12 and the damper 14 and turntable 3 sandwich the disk to drive the disk to rotate. Furthermore, the tray 2 moves back and forth in the horizontal direction by being supported by the horizontal wall 10A of the frame 10.

The tray 2 moves back and forth in the horizontal direction by being supported by the horizontal wall 10A of the frame 10 and the tray 2 is molded a flat shape as a whole through injection molding or the like. Substantially circular stepped recessed parts 2A, 2B are formed on the top surface of the tray 2; the first recessed part 2A allowing, for example, a 12-inch CD to be placed and the second recessed part 2B allowing, for example, an 8-inch CD to be placed.

The metal chassis 5 of the traverse unit 6 incorporates a pair of guide shafts 20 for guiding the pickup unit 4 in a freely slidable manner, a motor for moving the pickup unit 4 back and forth in the radial direction of the disk along the guide shafts 20 and a gear mechanism for transmitting the driving of the motor to the pickup unit 4 (all of which are not shown). Vibration-proof rubber 23 is attached on both sides of the rear end of the metal chassis 5 and the rear end of the metal chassis 5 is attached to the frame 10 through the vibration-proof rubber 23 in a floating manner. This allows a free end (front end side) of the metal chassis 5 to freely move in the vertical direction with the vibration-proof rubber 23 attached at the rear end on the opposite side as a pivot and allows the metal chassis 5 to freely incline with respect to the frame 10.

On the other hand, at the free end (front end side) of the metal chassis 5, a cam plate 25 which slides in the horizontal direction in junction with the operation of the tray 2 through an interlocking mechanism (not shown) is incorporated in the frame 10 in a freely slidable manner and a free end of the traverse unit 6 is engaged with a cam groove 26 formed in the cam plate 25. The means for engaging the cam plate 25 with the traverse unit 6 is not particularly limited, and in this embodiment, an end of the guide shaft 20 which protrudes from the metal chassis 5 is engaged with the cam groove 26 formed in the cam plate 25. When the cam plate 25 slides in the horizontal direction, an end of the guide shaft 20 guided by the cam groove 26 moves in the vertical direction and the free end (front end side) of the traverse unit 6 including the metal chassis 5 is made to move upward or downward with the vibration-proof rubber 23 as a pivot in conjunction with the vertical movement of the guide shaft 20. In this way, when the tray 2 goes into the frame 10 to the full extent, the cam plate 25 is made to slide, one end of the guide shaft 20 which is engaged with the cam groove 26 is made to ascend and the free end (front end side) of the metal chassis 5 thereby moves upward together with the guide shaft 20. As shown in FIG. 2, the metal chassis 5 is disposed substantially parallel to the horizontal wall 10A of the frame 10 allowing the damper 14 attached to the support plate 12 and the turntable 3 attached to the metal chassis 5 to sandwich and hold the disk and drive to rotate the disk placed on the tray 2.

In this way, when the tray 2 carries the disk and at the time the tray 2 goes into the frame 10 to the full extent, the interlocking mechanism (not shown) causes the cam plate 25 to slide so that the traverse unit 6 ascends, and therefore even when no disk is placed on the tray 2, the traverse unit 6 ascends when the tray 2 is carried in and the turntable 3 and damper 14 attract each other by a magnetic force. Therefore, the turntable 3 and the damper 14 collide with each other, the vibration thereof is transmitted to the metal support plate 12 which fixes the damper 14 and the support plate 12 amplifies noise. Therefore, this embodiment forms long holes 30 to suppress the vibration which is transmitted from the damper 14 to the support plate 12. The long hole 30 is formed according to the position at which the support plate 12 fixed to the frame 10 is formed. That is, as shown in FIG. 1 when the damper 14 is deviated forward or backward with respect to the center of the support plate 12, the long holes 30 are formed on the side having a wider area of the damper 14. Therefore, when the support plate 12 behind the damper 14 has a wider space, a pair of left and right long holes 30 are juxtaposed to each other behind the damper 14 and when the support plate 12 ahead of the damper 14 has a wider space as shown in FIG. 3, an oblong continuous long hole 30a is formed ahead of the damper 14. Furthermore, when the damper 14 is attached substantially in the center of the support plate 12 and the size of the support plate 12 in the depth direction is shorter than the width of the support plate 12, long holes 30b are formed on both sides of the damper 14 so as to face each other as shown in FIG. 4.

In the disk device 1 in the above described configuration, the long holes 30 are formed according to the position at which the support plate 12 fixed to the frame 10 is formed and when, for example, the tray 2 is carried in with no disk placed on the tray 2 and the turntable 3 and damper 14 collide with each other, it is possible to suppress vibration transmitted from the damper 14 to the support plate 12 at the time of collision by means of the long holes 30 or long hole 30a or long holes 30b and noise is never amplified by the support plate 12. Therefore, even when the turntable 3 and damper 14 directly contact each other, the contact sound can be reduced to a minimum level. Moreover, there is no need for providing a rubber ring separately as in the case of the conventional art and noise in the case where the turntable 3 and the damper 14 directly contact each other can be suppressed by an extremely simple method of forming the long holes 30 or long hole 30a or long holes 30b in the support plate 12, and it is thereby possible to simplify assembly work without causing any increase in the number of parts.

Moreover, when the damper 14 is deviated forward or backward with respect to the center of the support plate 12 according to the position of the damper 14 with respect to the support plate 12, the long holes 30 or long hole 30a are/is formed on the side having a wider area of the damper 14, or on the other hand when the damper 14 is attached in substantially the center in the front-back direction of the support plate 12, especially when the size in the depth direction of the support plate 12 is shorter than the width of the support plate 12, forming the long holes 30b on both sides of the damper 14 can effectively suppress vibration transmitting from the damper 14 to the support plate 12.

One embodiment of the present invention has been described in detail so far, but the present invention is not limited to the above described embodiment and can be implemented modified in various ways within a range not departing from the essence of the present invention. For example, the means for engaging the cam plate with the traverse unit may be selected as appropriate. Furthermore, the basic structure of the disk device or the like is not limited to the above described embodiment, either, and though the embodiment of the present invention has described a so-called tray type disk device equipped with a tray as a conveying mechanism for a storage medium, but the present invention is not limited to the tray type disk device and it is possible to select a structure other than the means for ascending/descending the traverse unit such as a slot-in type disk device which allows direct insertion of a storage medium or a changer type disk device which allows a plurality of storage media to be loaded as appropriate.

The effects of the present invention are as follows.

The recording and reproducing device according to the first aspect of the present invention is a recording and reproducing device including a conveying mechanism which conveys a disk-shaped storage medium, a frame to which the conveying mechanism is attached, a pickup unit which scans the storage medium carried into the frame, a turntable for rotating the storage medium, a damper provided opposite to the turntable; and a support plate suspended between side walls of the frame opposite to the clamper, the support plate being formed of a flat sheet metal, wherein long holes for suppressing vibration transmitting from the damper to the support plate when the damper comes into contact with the turntable are formed in the vicinity of the clamper, and can thereby restrain noise when the turntable and the damper contact each other using an extremely simple method of simply forming the long holes in the support plate without assembling any dedicated parts for suppressing vibration transmitted to the support plate separately and thereby reduce the number of parts and simplify assembly work.

The recording and reproducing device according to the second aspect of the present invention is the recording and reproducing device according to the first aspect of the present invention, wherein when the damper is attached at a position deviated forward or backward with respect to the center of the support plate, the long holes are at least formed on a side having a wider area ahead or behind the clamper, and can thereby effectively restrain the vibration transmitted from the damper to the support plate according to the position of the damper with respect to the support plate.

The recording and reproducing device according to the third aspect of the present invention is the recording and reproducing device according to the first aspect of the present invention, wherein the damper is attached substantially in the center of the support plate and when the size of the support plate in a depth direction is shorter than the width of the support plate, the long holes are at least formed on both sides of the clamper, and can thereby effectively restrain the vibration transmitted from the damper to the support plate even when the damper is attached substantially in the center of the support plate whose size in the depth direction is shorter than the width thereof.

What is claimed is:

1. A recording and reproducing device comprising:
a conveying mechanism which conveys a disk-shaped storage medium;
a frame to which the conveying mechanism is attached;
a pickup unit which scans the storage medium carried into the frame;
a turntable for rotating the storage medium;
a damper provided opposite to the turntable; and
a support plate suspended between side walls of the frame opposite to the clamper, the support plate being formed of a flat sheet metal,
wherein long holes for suppressing vibration transmitting from the damper to the support plate when the damper comes into contact with the turntable are formed in the vicinity of the clamper.

2. The recording and reproducing device according to claim 1, wherein when the damper is attached at a position deviated forward or backward with respect to the center of the support plate, the long holes are, at least formed on a side having a wider area ahead or behind the clamper.

3. The recording and reproducing device according to claim 1, wherein the damper is attached substantially in the center of the support plate and when the size of the support plate in a depth direction is shorter than the width of the support plate, the long holes are at least formed on both sides of the clamper.
